(19) United States
(12) Patent Application Publication
(10) Pub. No.: US 2014/0139183 A1
(43) Pub. Date: May 22, 2014

(54) Mobile Device Charger With Support Stand System

(71) Applicant: Robert Joseph Baschnagel, III, Garden City, NY (US)

(72) Inventor: Robert Joseph Baschnagel, III, Garden City, NY (US)

(21) Appl. No.: 13/680,483

(22) Filed: Nov. 19, 2012

(51) Int. Cl. H02J 7/00

(52) U.S. Cl. CPC H02J 7/0044
USPC 320/115; 320/107

(57) ABSTRACT

A mobile device charger is disclosed in the present invention. Said charger further comprising a stand member which can support the mobile device in either a standing horizontally or vertical position for easy viewing of the device screen. Said stand member may be constructed as a built-in part of the charger or may be construct as a separate adaptor which adapts the charger into a support system for the mobile device and allows for it to stand either horizontally or vertically on a table top.

### BACKGROUND OF THE INVENTION

1. Field of the Invention

The present invention relates to a battery charger with a support system built therein. More particularly, the present invention relates to a mobile device charger with a stand that can stand mobile devices horizontally and/or vertically.

2. Background of the Invention

Mobile devices, for example, mobile phones, iPads, and tablets are commonly used now. Most often, these mobile devices are powered by batteries. Because of the frequent use of these mobile devices, their batteries need to be re-charged frequently. Mobile device chargers are usually provided by the manufacturers along with the device. While charging, mobile devices are often laid on the table or things alike.

Also while using the mobile device, if the user wants to keep the screen of the mobile device horizontally or vertically positioned for continued use during the charging period, the user has to hold the device with his hands. Alternatively, the user may buy a holder or stand (e.g. in the case of iPads or tablets to keep the mobile device standing horizontally or vertically. Since the need to charge said device frequently happens when the user still needs to see the screen of the device the system described herein offers a built in approach for achieving charging as well as continued viewing of the device.

The chargers provided today along with mobile devices has the single function of charging the device. The feature enhancement that constitutes this invention is therefore desirable to have a the ability to charge and support the mobile device standing horizontally or vertically at the same time.

### SUMMARY OF THE INVENTION

In an exemplary embodiment of the present invention, there is disclosed a mobile device charger comprising:
i. a member for connection with an electric power source;
ii. a member for connection with said mobile device;
iii. a cord for connection of said member for connection with an electric power source and said member for connection with said mobile; and
iv. a stand member for keeping said mobile device standing horizontally or vertically while charging.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an illustration of one particular embodiment of the present invention.

FIG. 2 illustrates a mobile device standing vertically using a charger of one embodiment of the present invention.

FIG. 3 illustrates a mobile device standing horizontally using a charger of one embodiment of the present invention.

FIG. 4 illustrates a particular embodiment of the stand member of the present invention.

FIG. 5 illustrates the leg(s) of the stand member in a close (A) or an open (B) position of one embodiment of the present invention.

FIG. 6 illustrates the leg(s) of the stand member in a close (A) or an open (B) position of one embodiment of the present invention.

FIG. 7 illustrates the built-in stand member to hold mobile device vertically.

FIG. 8 illustrates the built-in stand member to hold mobile device horizontally.

FIG. 9 illustrates the stand member is constructed as an adaptor that holds mobile device horizontally or vertically.

FIG. 10 illustrates that the legs of the stand member can be opened and twisted to hold mobile device horizontally or vertically.

### DESCRIPTION OF THE PREFERRED EMBODIMENT

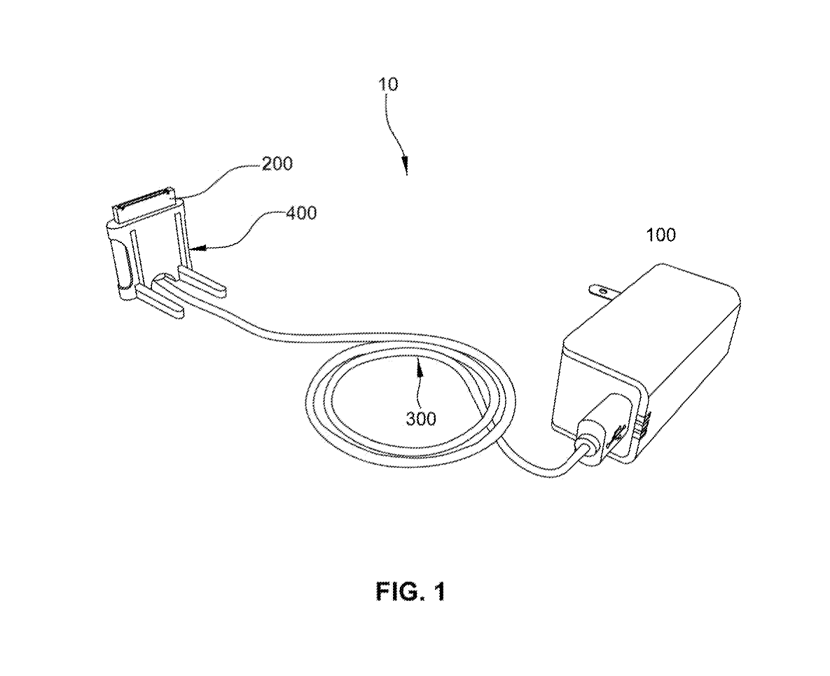

Referring to FIG. 1, there is disclosed a mobile device charger 10 comprising a member 100 for connection with an electric power source; a member 200 for connection with said mobile device; a cord 300 for connection of said member 100 for connection with an electric power source and said member 200 for connection with said mobile; and a stand member 400 for keeping said mobile device standing horizontally or vertically while charging.

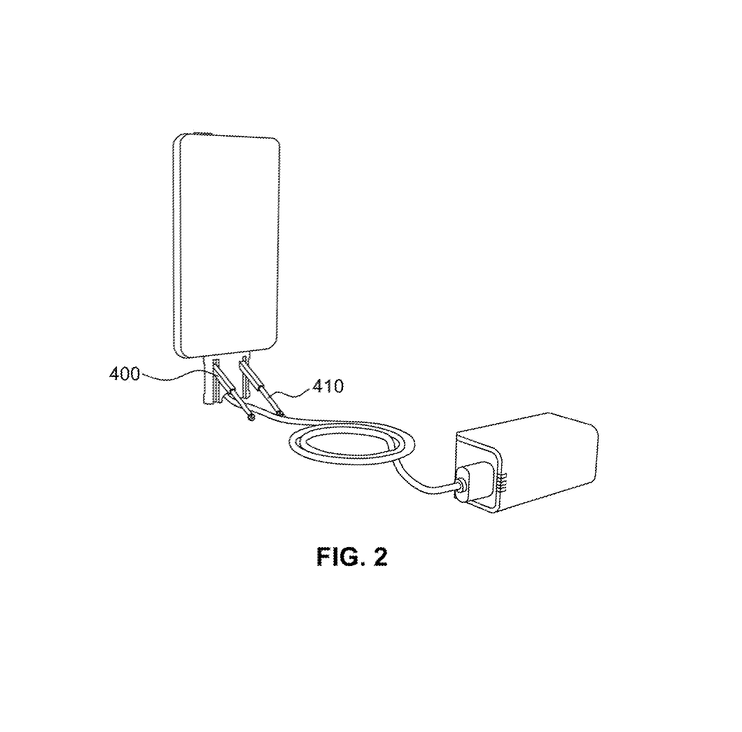

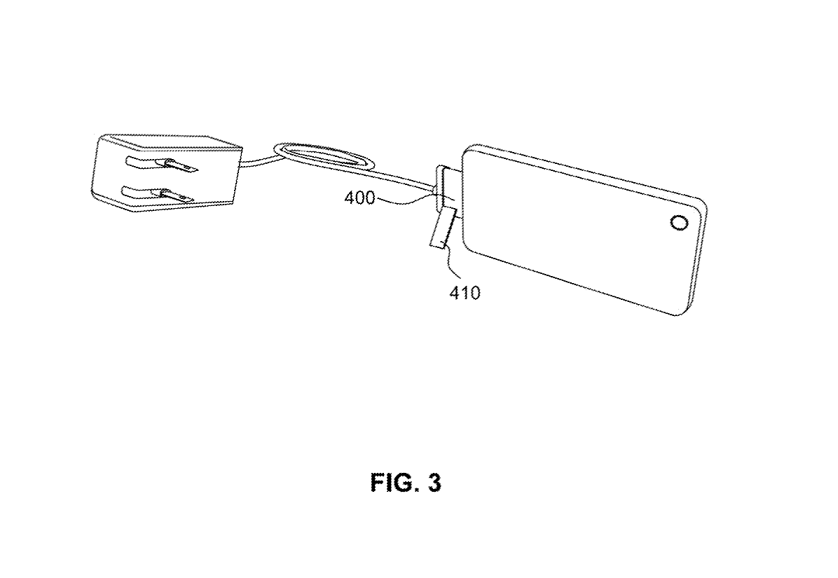

As shown in FIGS. 2 and 3, the stand member 400 further comprising at least on leg 410. Said leg 401 functions to support the mobile device standing vertically (FIG. 2) or horizontally (FIG. 3).

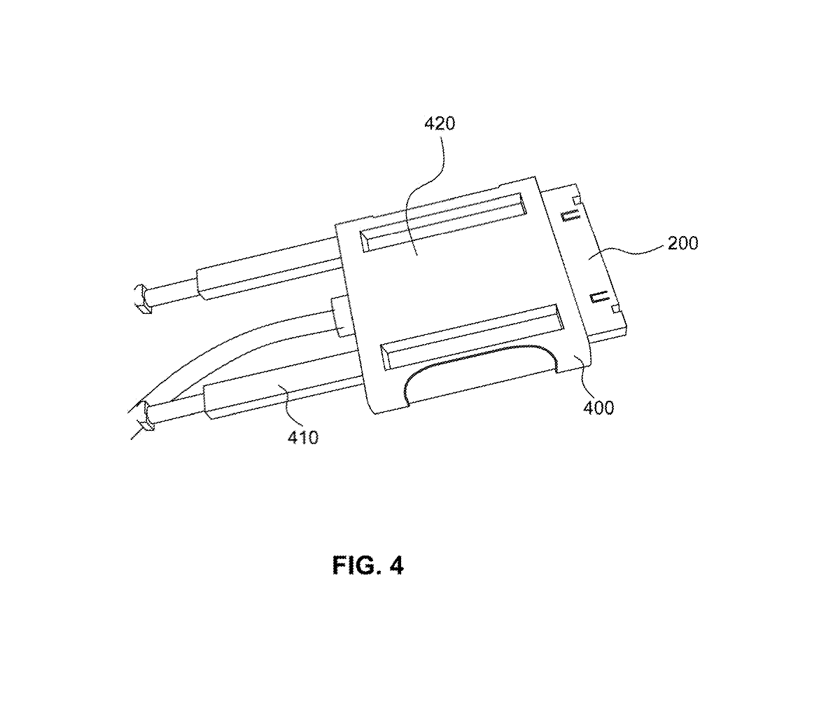

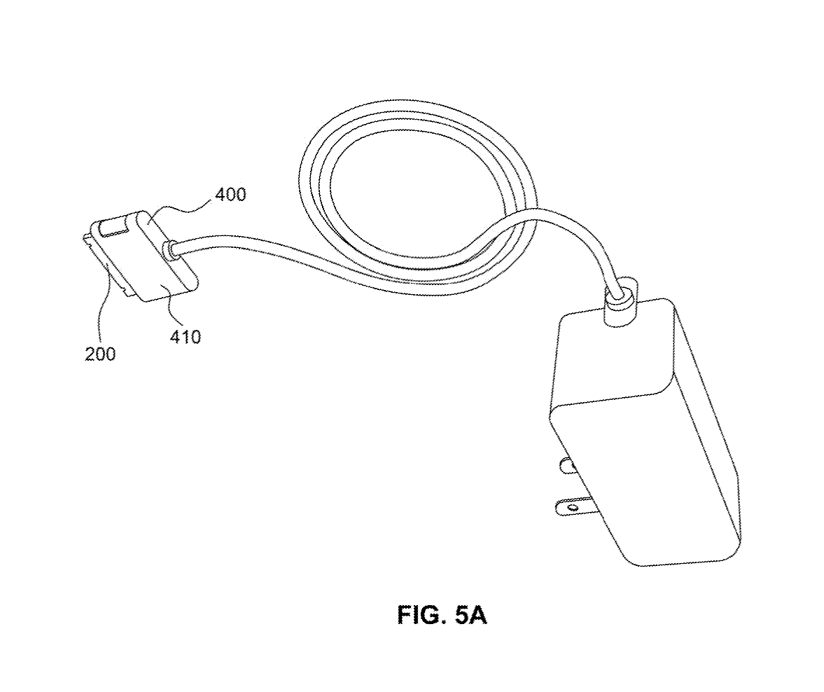

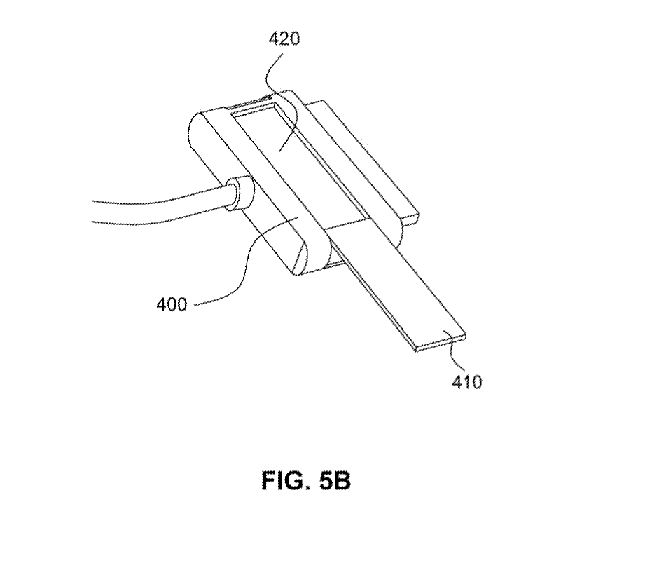

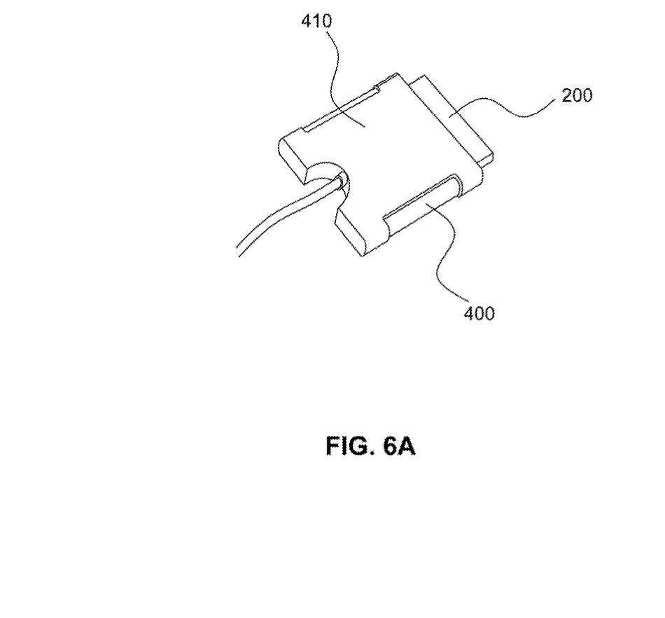

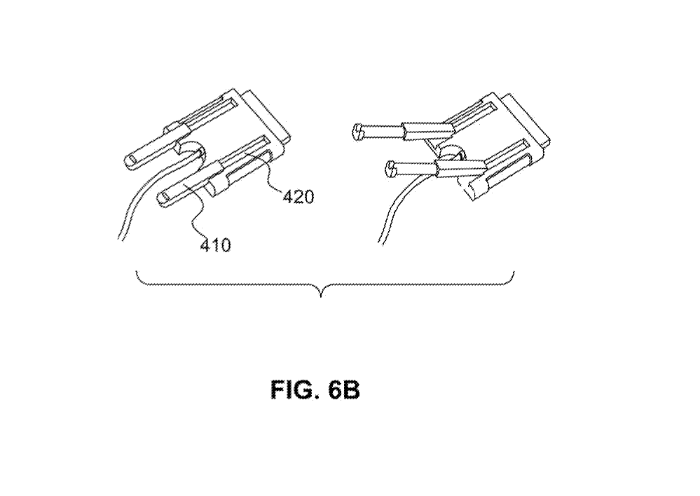

In one embodiment of the present invention as shown in FIG. 4, the stand member 400 may be a built-in part of the connection member 200. The stand member further comprising a space 420, which can hold the leg 410 when in a close position. As further illustrated in FIGS. 5 and 6, the legs may easily be switched between an open position or a close position by pulling out the leg 410 from the space 420 or by hiding the leg 410 into the space 420.

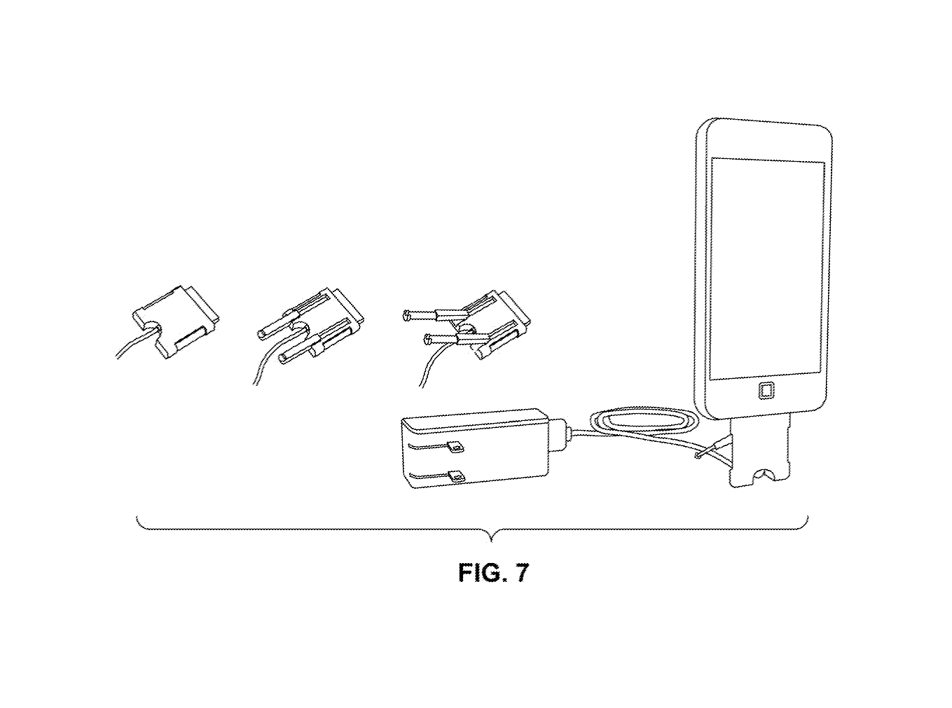

in one embodiment of the present invention as shown in FIG. 7, the stand member includes two legs which may slide along the space. In this embodiment, the mobile is held in vertical configuration. The legs may also slide along the space to form an angle of 0-90 degree with the stand member to allow the mobile device standing vertically with a different angle.

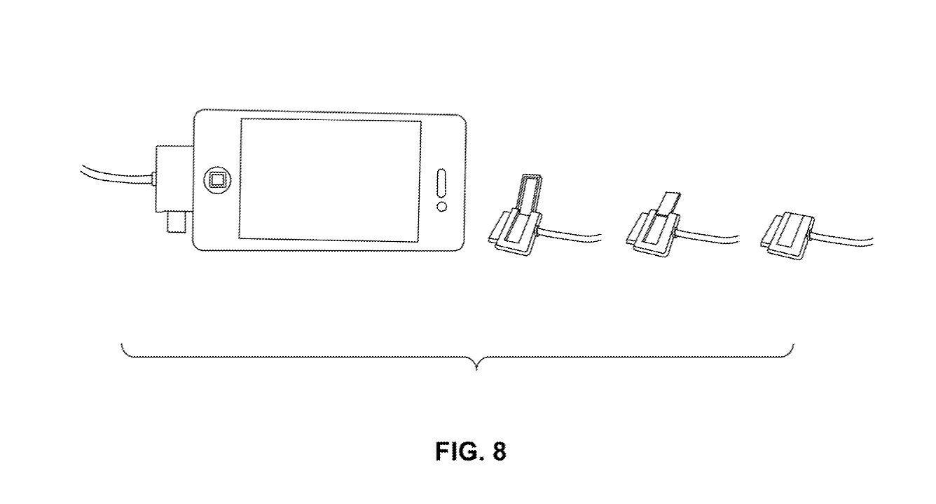

In another embodiment of the present invention as shown in FIG. 8, the stand member includes one legs. In this embodiment, the mobile is held in horizontal configuration. The legs may form an angle of 0-90 degree with the stand member to allow the mobile device standing horizontally with a different angle.

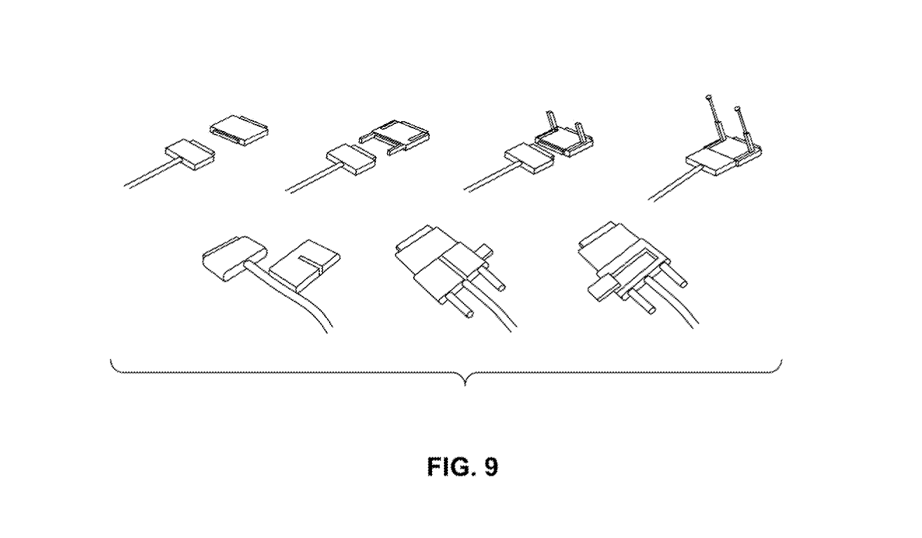

Yet in another embodiment of the present invention, the stand member may be constructed as a separate adaptor, as shown in FIG. 9. The adaptor adapts the connection member to mobile device, and includes leg(s) that either supporting mobile device standing vertically or supporting mobile device standing horizontally, or includes both.

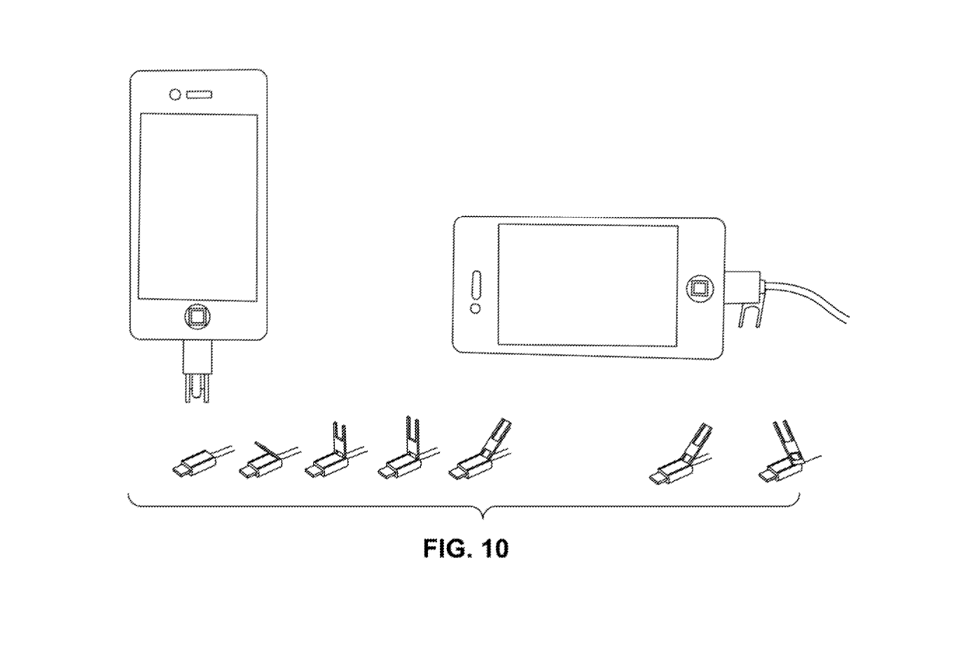

In another embodiment of the present invention as shown in FIG. 10, the stand member may include leg(s) that can be in a close or an open position. Said leg(s) may slide along the space and support the mobile device standing vertically. Said leg(s) may also be twisted 90 degrees and supports the mobile device standing horizontally. In either condition, the angle between said leg(s) and stand member may be adjustable for the mobile device to stand at a different angle. Additional legs could be added if more leverage is needed due to the weight of the phone.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A mobile device charger comprising:
i. a member for connection with an electric power source;
ii. a member for connection with said mobile device;
iii. a cord for connection of said member for connection with an electric power source and said member for connection with said mobile; and
iv. a stand member for keeping said mobile device standing horizontally or vertically while charging.

2. A mobile device charger of claim 1, wherein said mobile device may include, but not limited to, a mobile phone, an iPad, a tablet, or other mobile device alike.

3. A mobile device charger of claim 2, wherein said electric power source may include, but not limited to, AC or directional electric power, or an electronic device, including but not limited to a laptop computer, a desktop computer, or other electronic devices alike; and the connection to the electric power source may be a direct connection, via a DC adaptor, or via a USB connection.

4. A mobile device charger of claim 3, wherein said stand member has at least one leg for keeping said mobile device standing horizontally or vertically while charging.

5. A mobile device charger of claim 4, wherein said leg may be switch between an open or a close position.

6. A mobile device charger of claim 4, wherein said leg is adjustable to different angles to support said mobile device standing horizontally or vertically.

7. A mobile device charger of claim 4, wherein said stand member may be constructed as a part of said member for connection with said mobile device, or may be constructed as a separate adaptor, which adapts said member for connection with said mobile device and supports said mobile device standing horizontally or vertically.
